(19) United States
(12) Patent Application Publication
(10) Pub. No.: US 2022/0154521 A1
(43) Pub. Date: May 19, 2022

(54) SLIDE-AND-SWING WING SYSTEM

(71) Applicant: SUNFLEX Aluminiumsysteme GmbH, Wenden (DE)

(72) Inventor: Ernst-Josef SCHNEIDER, Wenden (DE)

(73) Assignee: SUNFLEX Aluminiumsysteme GmbH, Wenden (DE)

(21) Appl. No.: 17/439,572

(22) PCT Filed: Sep. 28, 2020
(86) PCT No.: PCT/EP2020/077131

§ 371 Date: Sep. 15, 2021

(30) Foreign Application Priority Data
Dec. 13, 2019 (EP) 19215952.3

(51) Int. Cl. E06B 3/50; E05D 15/48; E05C 5/02; E05F 11/02; E05B 65/08

(52) U.S. Cl. CPC E06B 3/5072; E05D 15/48; E05C 5/02; E05F 11/02; E05B 65/0835; E05B 65/087; E05Y 2900/132; E05Y 2201/638; E05Y 2201/684; E05Y 2201/686; E05Y 2201/688; E05Y 2201/722; E05Y 2800/102; E05D 2015/485

(57) ABSTRACT

A slide-and-swing wing system includes at least one rail profile. At least two wings, each displaceably mounted in the at least one rail profile via two support elements The at least one rail profile has a lateral outlet opening for unlatching a support element of a wing. One wing functions as a door leaf which, with all other wings in the latched state, is pivotable into the remaining opening. A closure mechanism makes it possible to prevent the door leaf from being opened and includes a drive, and also an operating part, via which the drive can be actuated. The door leaf is displaceable, via the drive, in the rail profile in the direction of the adjacent wing to such an extent that no support element of the door leaf is aligned with the outlet opening, thereby preventing a support element from coming out through the lateral outlet opening.

The invention relates to a slide-and-swing sash system in accordance with the preamble of claim 1.

Such slide-and-swing sash systems are sufficiently known. They have multiple window sashes, which can be pivoted individually, and thereby a façade division or room partition, which is generally very large, can be opened almost completely. The individual sashes are displaceably guided in guide rails arranged on the ceiling and on the floor. In this regard, each sash is displaceably held in a ceiling profile by way of two support elements. On the floor side, each sash is guided in the floor rail, generally by way of a carriage part. To pivot a sash, the guide rails have an outlet opening for unlatching a support element or a guide carriage of a sash. A slide-and-swing sash system of the above type is described, for example, in EP 2 546 441 A1. An outer sash of the slide-and-swing sash system functions as a door sash that can be pivoted into the remaining opening in the latched state of all the other sashes, and thereby the façade division or room partition is completely closed. In order to prevent unauthorized opening, this door sash is provided with a closure mechanism that prevents the door sash from being pivoted out. Such a closure mechanism is regularly configured in the form of a latch that is guided in a guide on the sash and can be introduced into a rail.

It is a disadvantage of the known closure mechanism that the latch has only a slight insertion depth in the rails, which run horizontally. As soon as the door sash is subject to horizontal stress, for example due to wind, the locking device can fail and therefore the sash can open unintentionally.

This is where the invention wishes to provide a remedy. The invention is based on the task of making available a slide-and-swing sash system having a closure mechanism that guarantees reliable latching even in the event of horizontal stress on the door sash due to wind. According to the invention, this task is accomplished by means of a slide-and-swing sash system having the characteristics of the characterizing part of claim 1.

With the invention, a slide-and swing sash system having a closure mechanism is made available, which mechanism guarantees reliable latching even in the event of a horizontal wind load on the door sash. Because of the fact that the closure mechanism comprises an operating part by way of which a drive can be activated, by way of which drive the door sash can be displaced in the rail profile, in the direction of the adjacent sash, to such an extent that no support element aligns with the outlet opening, exiting of a support element through the lateral outlet opening is reliably prevented. Preferably, a ceiling rail profile and a floor rail profile are provided, which each have a lateral outlet opening and in which the at least two sashes are guided.

The term “floor part” should be understood to mean any device for activation of a drive, such as a button for activation of an electrical, pneumatic or hydraulic drive, or an operating lever for activation of a mechanical drive.

In a further development of the invention, the operating part is an operating lever, and the drive is a mechanical drive that is configured in such a manner that a rotational movement of the operating lever can be converted to a horizontal movement of the door sash along the rail profile or parallel to it, wherein the operating lever can be locked in place, preferably at least in the closed position. It is advantageous if the operating lever can additionally be locked in place, thereby preventing unauthorized opening. Preferably a side profile is arranged orthogonal to the at least one rail profile, which side rail forms a counter-bearing for the drive.

In an embodiment of the invention, the drive is arranged on the door sash and has a thrust element that is connected with a side profile that is provided and can be moved out against the side profile by means of rotation of the operating lever, which profile functions as a counter-bearing, and thereby a thrust force on the door sash is brought about. In this way, mechanically reliable displacement of the door sash is made possible.

In a further development of the invention, a holding block is provided in the side profile, which block has a holder for the thrust element, into which the thrust element engages in the pivoted-in position of the door sash. In this way, the thrust element is fixed in place on the side profile in the closed position of the door sash.

In a further embodiment of the invention, the drive is arranged on the side profile and has a thrust element that is connected with the door sash with shape fit in the pivoted-in position of the door sash, wherein the thrust element can be moved out against the door sash by means of rotation of the operating lever, thereby bringing about a thrust force on the door sash.

In a further development of the invention, a mushroom head is arranged on the door sash, which head engages into a T-shaped recess of the thrust element when the door sash is pivoted in.

In a further embodiment of the invention, the drive is arranged on a side profile and comprises a thrust rod that can be displaced vertically by means of rotation of the operating lever, and is connected with a thrust piece that is connected with the door sash, by way of a transformation arrangement, wherein the transformation arrangement is set up for transforming a vertical movement of the thrust rod into a horizontal movement of the thrust piece. In this way, a drive that can be positioned at a position of the side profile that cannot be seen is made possible, which drive is arranged outside of the door sash. In this way, modification of a sash for use as a door sash is made unnecessary. The term “transformation arrangement” should be understood to mean an arrangement of components, by way of which transformation or redirection of a vertical movement of a thrust rod into a horizontal movement of a thrust element is made possible. Preferably the transformation arrangement has a cam disk, a crank drive or a gearwheel mechanism for redirection of a vertical movement of the thrust rod into a horizontal movement of the thrust piece.

In a further development of the invention, the transformation arrangement comprises a compulsory guide that is connected with the thrust piece and in which an entrainer part connected with the thrust rod is guided. In this regard, the entrainer part is preferably formed by a slide pin preferably set against the thrust rod at an angle, which pin is guided in the channel of the compulsory guide. It is advantageous if the slide pin is set against the thrust rod at an angle of between 30° and 55°, preferably between 35° and 50°, particularly preferably of 45°. The translation between thrust rod and slider can be adjusted by way of the angle of the slide pin. At a preferred angle of 45°, maximum horizontal movement of the slider during vertical movement of the thrust rod is achieved.

In an embodiment of the invention, the slider is connected with a support element of the door sash. In this way, a covered connection of the slider with the door sash is made possible. Preferably the slider projects into a rail profile, and thereby it is completely covered.

In a further development of the invention, the slider is connected with the support element of the door sash on the ceiling side. In this way, the risk of tilting of the door sash is reduced.

In an embodiment of the invention, a clamping piece is mounted in the side profile so as to pivot, which piece surrounds the door sash in the closed position. In this way, the door panel is laterally stabilized in the closed position. At the same time, the clamping piece bridges the distance from the side profile that occurs as the result of the displacement of the door sash.

In a further embodiment of the invention, the clamping piece has two holding arms arranged opposite one another, between which the door sash slides when it is pivoted into the closed position, and out of which it slides when it is pivoted out of the closed position. In this way, automatic fixation of the door sash is achieved when it is pivoted into the closed position. Preferably, one arm is straight and the opposite arm is configured angled away relative to the first arm. In this way, a clamping effect is achieved when the door sash slides in.

In a further development of the invention, a bearing block is introduced into the side profile, which block has an axle holder into which an axle of the clamping piece engages, wherein the clamping piece is guided in the side profile by means of a recess introduced into the side profile for this purpose. In this way, stable and, at the same time, easily installed pivoting mounting of the clamping piece on the side profile is achieved. Preferably the outer contour of the bearing block is configured in accordance with the inner contour of the side profile. In this way, shape-fit attachment is brought about. In this regard, the bearing block is particularly preferably produced from an elastomer, with an excess dimension. In this way, shape-fit and force-fit attachment of the bearing block within the side profile is brought about.

In an embodiment of the invention, alternatively or in addition, the clamping piece is also produced from an elastomer material. In this way, an improved clamping effect of the arms that are arranged opposite one another is achieved.

In a further embodiment of the invention, the clamping piece is pre-loaded in a pivoting direction by way of a spring element, preferably a torsion spring. In this way, constant contact of an arm on the door sash is brought about.

Other further developments and embodiments of the invention are indicated in the other dependent claims. Exemplary embodiments of the invention are shown in the drawings and will be described in detail below. The figures show:

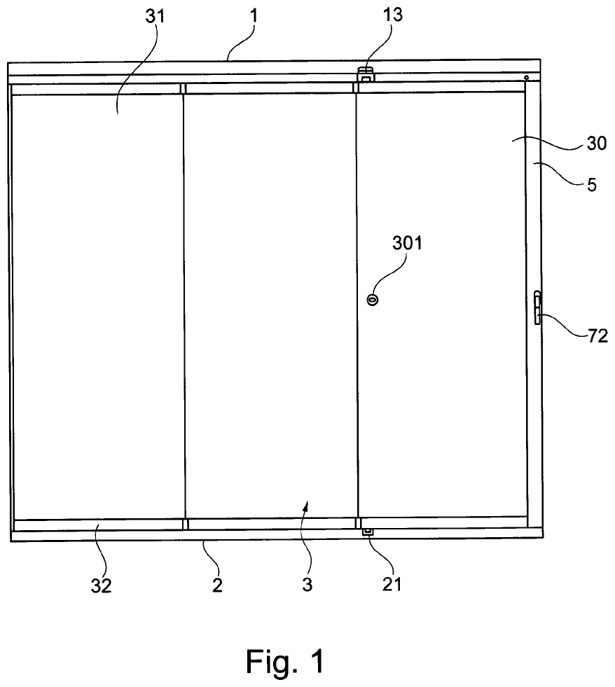

FIG. 1 the schematic representation of a slide-and-swing sash system;

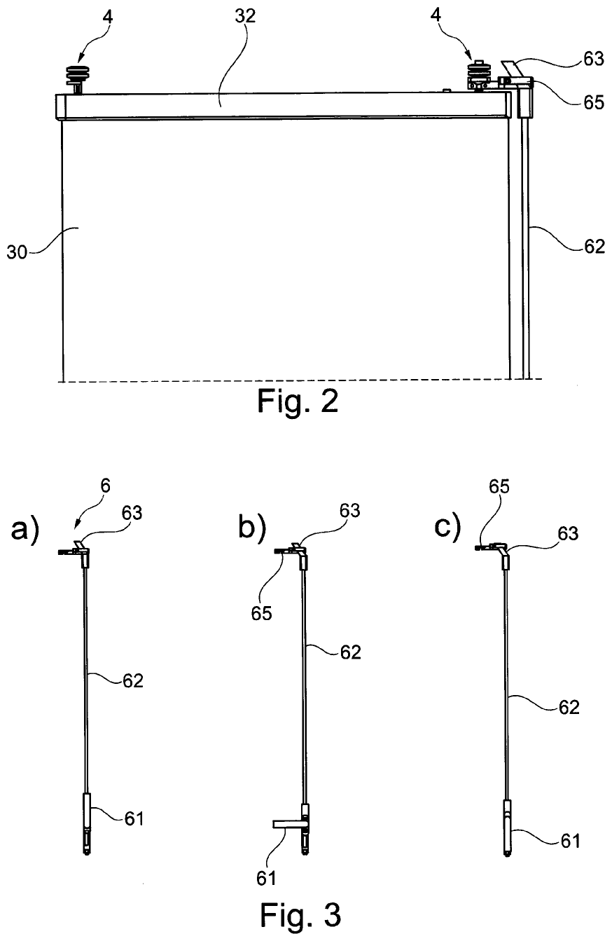

FIG. 2 the schematic representation of the upper region of the door sash of the slide-and-swing sash system from FIG. 1 with the ceiling rail not shown;

FIG. 3 the schematic representation of the closure mechanism of the door sash from FIG. 2
a) in the open position;
b) in the half-open intermediate position;
c) in the closed position;

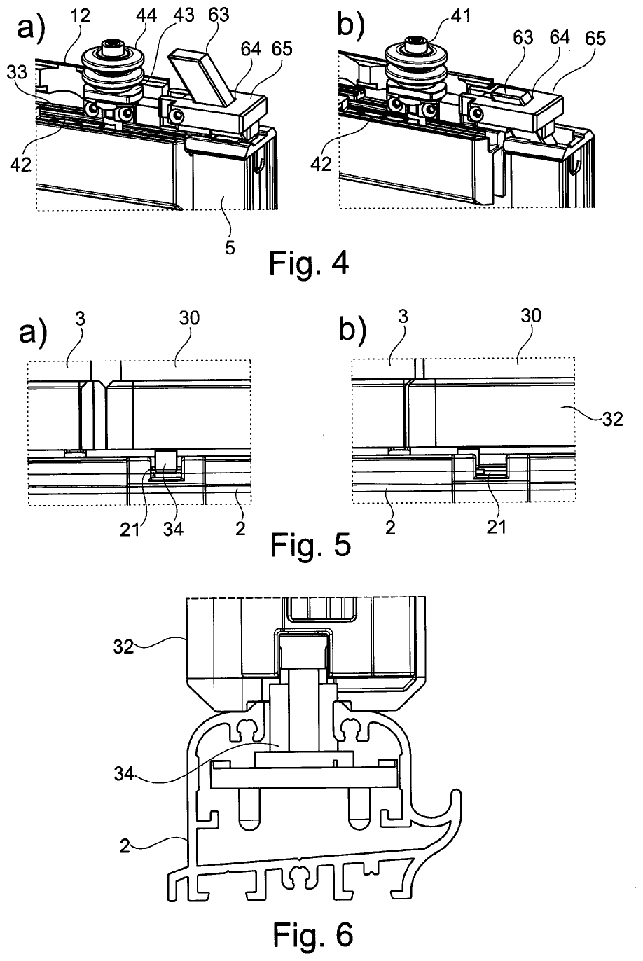

FIG. 4 the detail view of the compulsory guide of the closure mechanism from FIG. 3
a) in the open position;
b) in the closed position;

FIG. 5 the schematic representation of the position of the door sash with guide carriage in the bottom rail
a) in the open position of the closure mechanism;
b) in the closed position of the closure mechanism;

FIG. 6 the schematic representation of the guide of the door sash in the floor profile in cross-section;

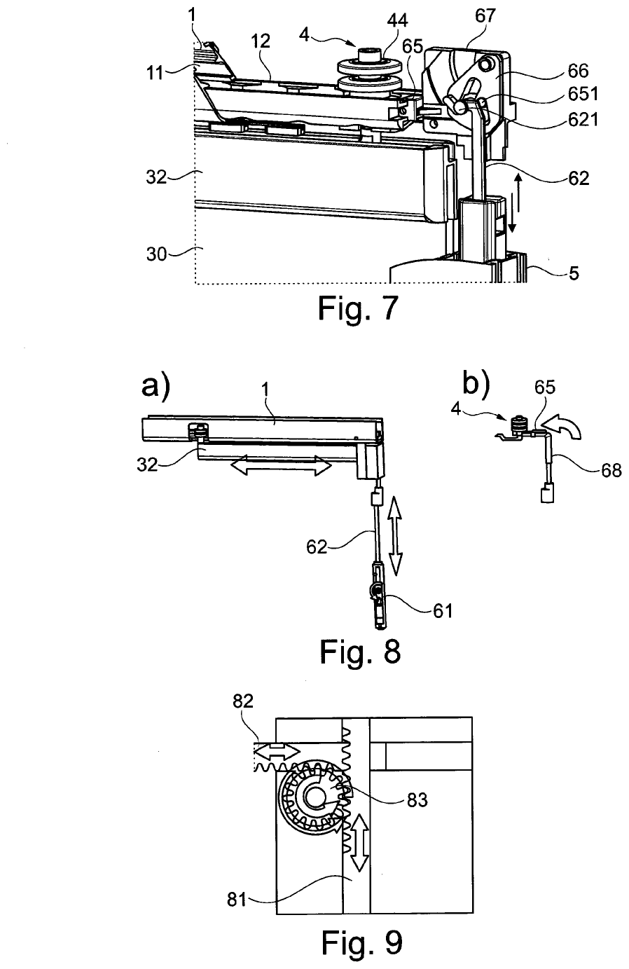

FIG. 7 the schematic representation of the transformation arrangement of a slide-and-swing sash system in a further embodiment;

FIG. 8 the schematic representation of the transformation arrangement of a closure mechanism in a third embodiment
a) in a spatial representation;
b) in a detail representation;

FIG. 9 the schematic representation of the transformation arrangement of a closure mechanism in a fourth embodiment;

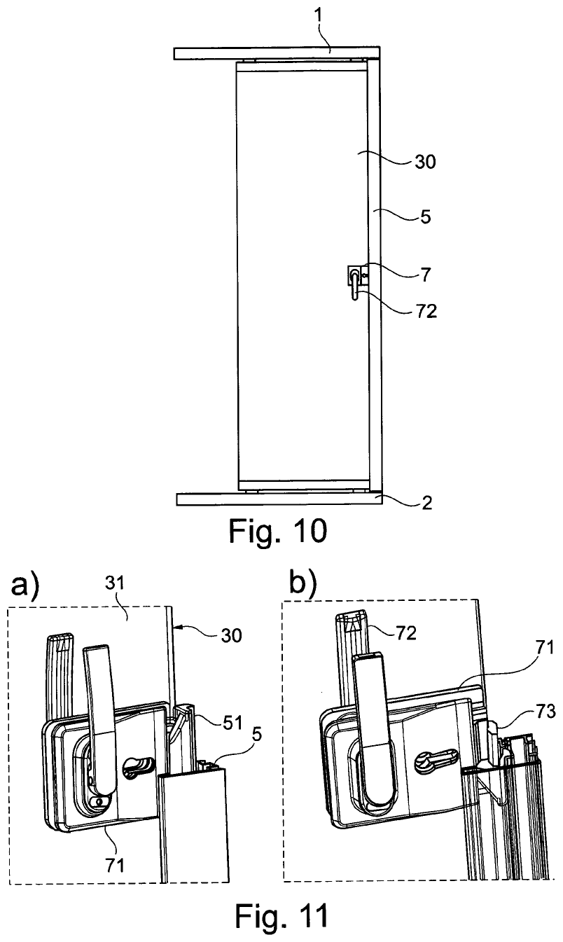

FIG. 10 the door sash of a slide-and-swing sash system in a fifth embodiment;

FIG. 11 the detail representation of the door sash from FIG. 10 with closure mechanism in engagement with the side profile
a) with the rail profile in cross-section;
b) with the holding block in cross-section;

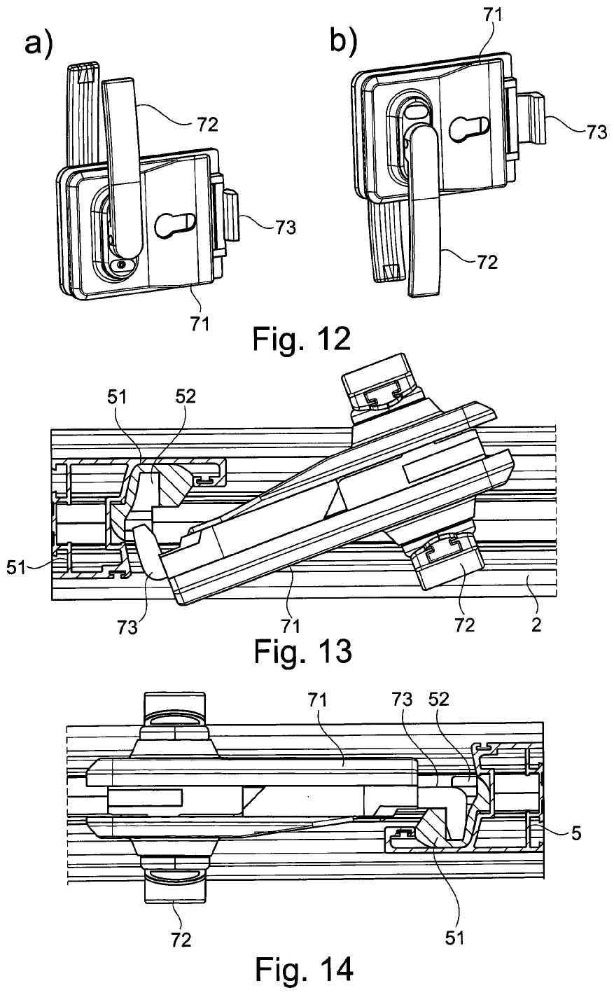

FIG. 12 the schematic representation of the closure mechanism from FIG. 11
a) in the open position;
b) in the closed position;

FIG. 13 the schematic representation of the closure mechanism of the door sash of the slide-and-swing sash system from FIG. 10 with the door sash open;

FIG. 14 the schematic representation of the closure mechanism of the door sash from FIG. 10 in a closed position of the door sash;

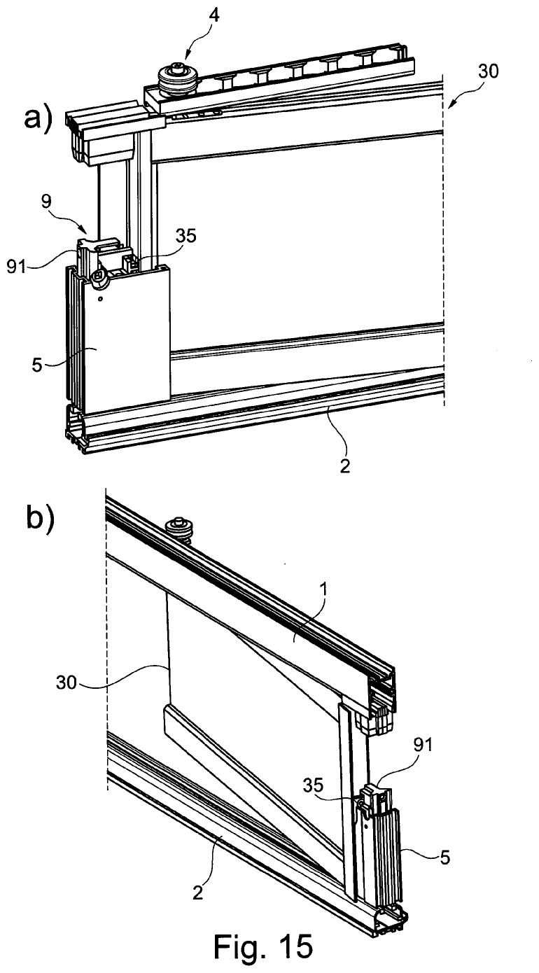

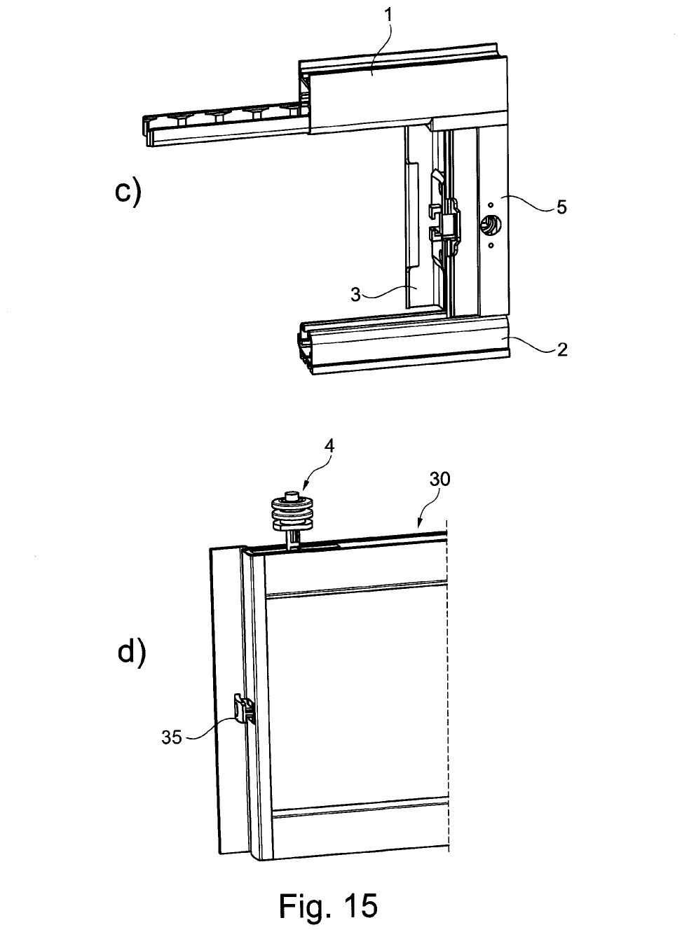

FIG. 15 the door sash of a slide-and-swing sash system with closure mechanism in a sixth embodiment
a) in a spatial representation from the front;
b) in a spatial representation from the rear;
c) in a detail representation of the closure mechanism;
d) in a detail view of the sash section on the closure mechanism side;

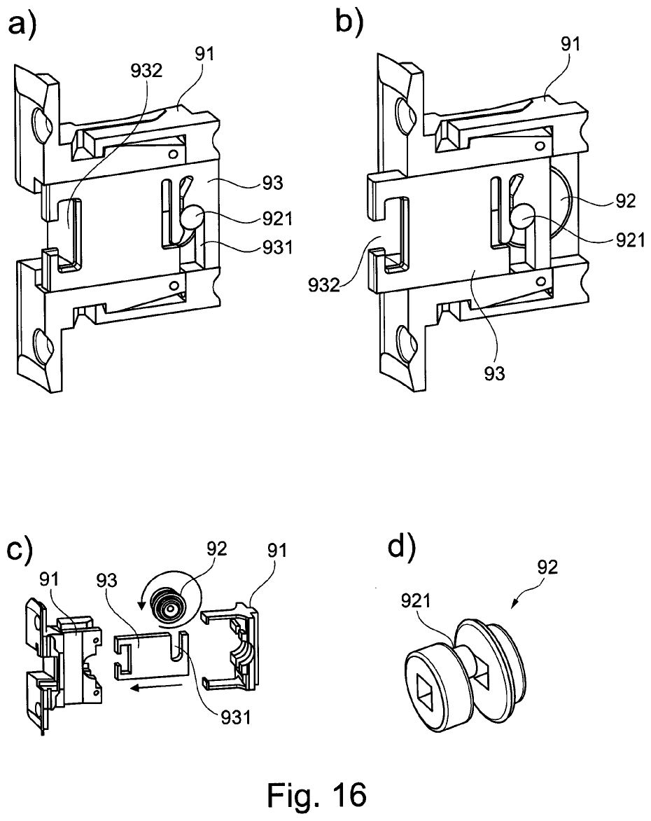

FIG. 16 the schematic representation of the transformation arrangement of the closure mechanism from FIG. 13
a) in the retracted position of the thrust element;
b) in the extended position of the thrust element;
c) in an exploded representation;
d) in a detail representation of the swing cylinder;

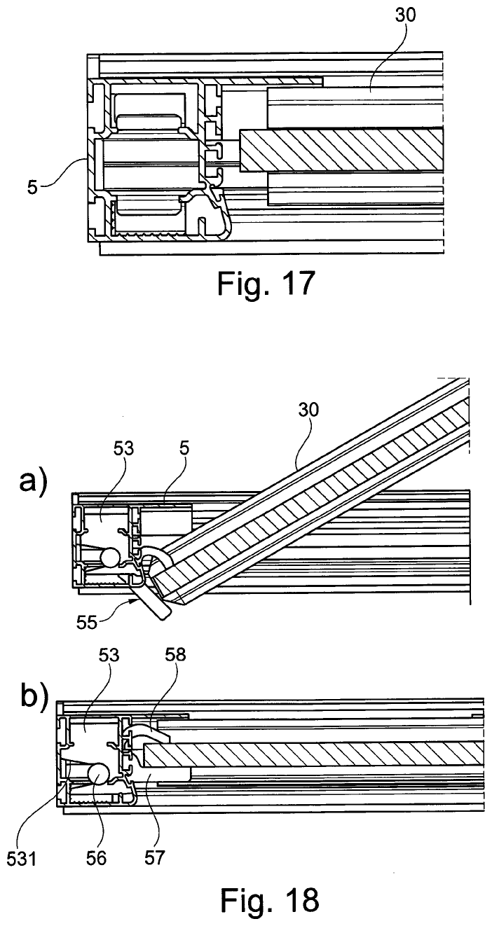

FIG. 17 the schematic representation of the door sash of a slide-and-swing sash system with side profile in cross-section;

FIG. 18 the representation of the arrangement from FIG. 17 with a clamping piece in place
a) with the door sash in the open swing position;
b) with the door sash in the closed position;

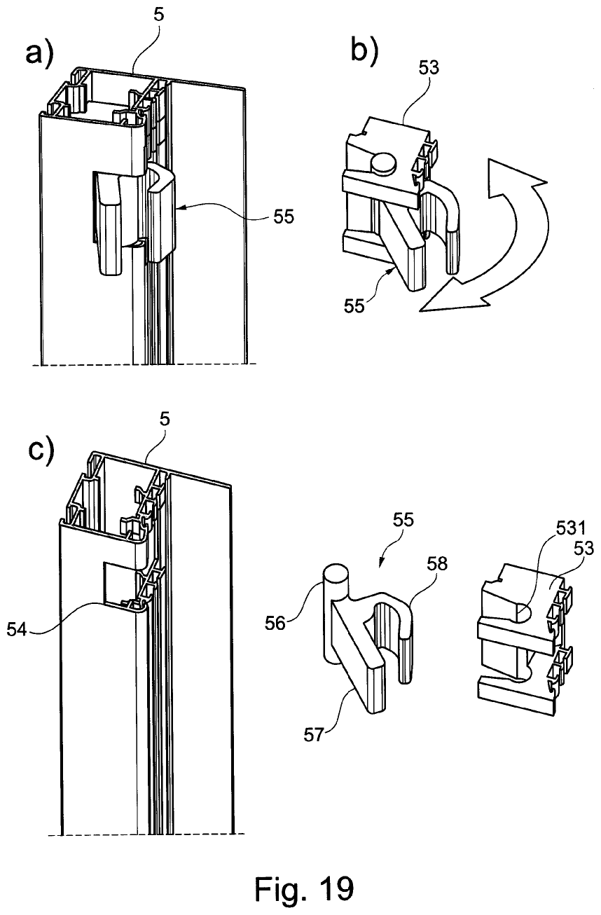

FIG. 19 the side profile from FIG. 18
a) in a spatial representation;
b) in a detail representation of the clamping piece with bearing block;
c) in an exploded representation.

The slide-and-swing sash system chosen as an exemplary embodiment consists essentially of a ceiling rail profile 1 and a floor rail profile 2, as well as a number of sashes 3, which are guided in the ceiling rail profile 1 by way of support parts 4 and in the floor rail profile 2 by way of guide carriages 34. On the end side, a side profile 5 is arranged between ceiling rail profile 1 and floor rail profile 2.

The ceiling rail profile 1 is configured essentially in the manner of a C profile. In the ceiling rail profile 1, guide grooves 11 are provided on its side walls, lying opposite one another, to hold the guide rollers 44 of the support parts 4 of the sashes 3. Below the guide grooves 11, an expansion clamp 12 is inserted into the ceiling rail profile 1 on the end side. Ahead of the expansion clamp 12, an outlet opening 13 is introduced into the ceiling rail profile 1, on the side, for releasing a support part 4 of a sash 3.

The expansion clamp 12 is configured as a pincer-shaped plastic part. In the arms of the expansion clamp 12 that are arranged opposite one another, arc-shaped formations are arranged, one after the other, which are provided, approximately in the center, with a groove for holding the guide plate 43 of a support part 4. The radius of the arc-shaped formations essentially corresponds to the radius of the guide rollers 44 of the support parts 4.

The floor rail profile 2 is configured essentially in C shape and has a longitudinal slot on its side that faces the ceiling rail profile 1, in which slot the guide carriage 34 of the sashes 3 is guided. On the side, an outlet opening 21 is introduced into the floor rail profile 2, lying opposite the outlet opening 13 of the ceiling profile 3, which opening is enclosed by a guide frame.

The sashes 3 are each formed by a pane element 31 that is enclosed, on the end sides, with frame profiles 32. The frame profile 32 of a sash 3 that faces the ceiling rail profile 1 has a formation 33 in the manner of a C profile, in each instance, to hold the groove plates 42 of the support parts 4. In the exemplary embodiment, each sash 3 is provided with two support parts 4, which are introduced into the C-profile-type formation 33 of a sash 3.

The support part 4 is essentially formed by a cylinder part 41, which is arranged on the end side with a groove plate 42 for engagement into the C-profile-type formation 33 of the frame profile 32 of a sash 3. The groove plate 42 is connected with the frame profile 32 of a sash 3 by means of screws. A guide plate 43 is formed on, lying opposite the groove plate 42, on which guide plate two guide rollers 44 are mounted on the cylinder part 41 so as to rotate, one on top of the other.

The outer sash that faces the side profile 5 takes on the function of a door panel 30. The pane element 31 of the door panel 30 is provided with an operating knob 301. A closure mechanism 6 is arranged on the side profile 5, by way of which mechanism the door panel 30 can be displaced in the direction of the adjacent sash 3.

The closure mechanism 6 comprises an operating lever 61 that is attached to the side profile 5 so as to rotate, which lever is connected with a thrust rod 62 mounted on the side profile 5 so as to be displaceable, in such a manner that a rotational movement of the operating lever brings about a vertical displacement of the thrust rod 62. On its end facing away from the operating lever 61, a slide pin 63 is arranged on the thrust rod 62, set at an angle to it, which pin engages into a channel 64 of a thrust piece 65. In the exemplary embodiment, the slide pin 63 has a rectangular cross-section, the outer mantle surface of which essentially corresponds to the inner mantle surface of the channel 64 of the thrust piece 65. In the exemplary embodiment, the slide pin 63 encloses an angle of 150° with the thrust rod 62 as well as an angle of 60° with the thrust piece 65. The channel 64 of the thrust piece 65 encloses the slide pin 63, lying against it, in such a manner that the slide pin 63 is compulsorily guided in the channel 64 of the thrust piece 65. The thrust piece 65 is attached to the cylinder part 41 of the support part 4 of the door panel 30 that faces it, as shown in FIG. 4.

The method of functioning of the closure mechanism 6 is shown in FIG. 3. In the open position of the door panel 30, the operating lever 61 is in an upper position. Here, the thrust piece 65 is positioned in the lower region of the slide pin 63. In this position, the door panel 30 almost lies against the side profile 5. The support part 4 is in alignment with the outlet opening 13 of the ceiling rail profile 3. Likewise, the guide carriage 34 of the door panel 30 is in alignment with the outlet opening 21 of the floor rail profile 2, so that it is possible to pivot the door panel 30 out (see FIG. 5a). If the operating lever 61 is pivoted downward, the thrust piece 65, which is compulsorily guided by way of the channel 64, slides along the slide pin 63, which is set at an angle, and thereby the thrust piece 65, as well as the support part 4 of the door panel 30, which is connected with it, is displaced in the direction of the adjacent sash 3. In the position according to FIG. 3c, the door panel 30 lies against the adjacent sash 3. In this position, the support part 4 and the guide carriage 34 are no longer in alignment with the outlet openings 13, 21 of the ceiling rail profile 1 and of the floor railing profile 2, respectively (see FIG. 5b). In this position, pivoting the door panel 30 out is not possible.

In the exemplary embodiment according to FIG. 7, a cam disk 66 is provided in place of the slide pin that is compulsorily guided in a channel of the thrust piece, which disk is mounted in a housing 67 that is attached to the side profile 5. Here, a guide pin 621 is arranged on the end side of the thrust rod 62, which pin engages into the cam disk 66. The thrust piece 65 also engages into the cam disk 66, by way of a guide pin 651. In this regard, thrust rod 62 and thrust piece 65 are connected by way of the cam disk 66, in such a manner that a vertical displacement of the thrust rod 62 brings about a horizontal displacement of the thrust piece 65, which in turn is connected with the support part 4 of the door panel 30. An upward movement of the thrust rod 62 brings about a rotation of the cam disk 66 in the counter-clockwise direction, and thereby the thrust piece 65 is displaced to the left (see FIG. 7). A downward movement of the thrust rod 62 in turn brings about a rotation of the cam disk in the clockwise direction, and thereby the thrust piece 65 is moved in the direction of the side profile 5.

In FIG. 8, a transformation arrangement of a closure mechanism of a further embodiment is shown. In this regard, thin sheet-metal strips 68 are guided in a guide that is curved by 90 degrees, and thereby the vertical movement of the thrust rod 62, which is brought about by means of a rotation of the operating lever 61, is transformed into a horizontal movement of the thrust piece 65.

A further transformation arrangement for a closure mechanism of a further embodiment is outlined schematically in FIG. 9. In this regard, the thrust rod (not shown) is connected, on the end side, with a first gear rack 81, which is in engagement with a stationary gearwheel 83 that is mounted so as to rotate. A second, horizontal gear rack 82 is connected with the thrust piece (not shown) and is also in engagement with the gearwheel 83. A vertical movement of the thrust rod can thereby be transferred to the gearwheel 83 by way of the first gear rack 81, and, by way of this gearwheel, into a horizontal movement of the second gear rack 82 and to the thrust piece connected with it.

In the exemplary embodiment according to FIG. 10, a closure mechanism 7 is arranged on the door panel 30 on its side that faces the side profile 5, which mechanism comprises a housing 71 in which an operating lever 72 is mounted so as to pivot. The housing 71 is firmly connected with the disk element 31 of the door panel 30. Furthermore, a thrust piece 73 is displaceably mounted in the housing 71 and connected with the operating lever 72 in such a manner that a rotation of the operating lever 72 brings about a horizontal displacement of the thrust piece 73. The thrust piece 73 in turn is connected with the engagement space 52 of a holding block 51, which block is firmly connected with the side profile 5, inside it.

Engagement of the thrust piece 73 into the holding block 51 of the side profile 5 is shown in FIG. 11. A rotation of the operating lever 72 brings about a horizontal displacement of the thrust piece 73, which is held in the holding block 51, and thereby the door panel 30 is displaced relative to the side profile 5. In the position according to FIG. 12 a), the thrust piece 73 has been moved into the housing 71, and thereby the door panel 30 lies against the side profile 5. In this position, the support part 4 and the guide carriage 34 of the door panel 30 are in alignment with the outlet openings 13, 21 of the ceiling rail profile 1 and of the floor rail profile 2, respectively. In this position, the door panel 30 can be pivoted out. In the rotation position of the operating lever 72 according to FIG. 12 b), the thrust piece 73 is maximally moved out of the housing 71, and thereby the door panel 30 lies against the adjacent sash 3. In this position, the support part 4 and the guide carriage 34 of the door panel 30 are out of alignment with the outlet openings 13, 31 of ceiling rail profile 1 and floor rail profile 2, respectively; in this position, pivoting of the door panel 30 is not possible.

In FIG. 13, pivoting the door panel 30 out is shown in longitudinal section. As can be seen, the thrust piece 73 is moved out of the engagement space 52 of the holding block 51 of the side profile 5 during the course of the pivoting movement of the door panel 30. Accordingly, the thrust piece 73 gets back into engagement with the holding block 51, as shown in FIG. 12, when the door panel 30 is pivoted in.

In the exemplary embodiment according to FIG. 15, a closure mechanism 9 is arranged on the side profile 15, on its side facing the door panel 30, which mechanism comprises a housing 91 in which a rotary cylinder 92 is arranged so as to rotate, which cylinder is connected with a handle piece—not shown. The rotary cylinder 92 has an eccentric tappet 921 that engages into a motion link 931 of a thrust piece 93 that is mounted in the housing 91 so as to be displaceable. The thrust piece 93 has a T-shaped recess 932 on its end facing the door panel 30, into which recess a mushroom head 35 arranged on the door panel 30 slides when the door panel 30 is pivoted in. A horizontal displacement of the thrust piece 93 as well as of the door panel 30 connected with it by way of the mushroom head 35 is brought about by means of a rotation of the rotary cylinder 92.

In the exemplary embodiment according to FIG. 18, a bearing block 53 is introduced into the side profile 5, the outer contour of which block essentially corresponds to the inner contour of the side profile 5 with oversize. The bearing block 53 is produced from an elastomer material and is held in the side profile 5 with shape fit and force fit. At the level of the bearing block 53, a recess 54 is introduced into the side profile 5, through which recess a clamping piece 55 is guided, which is mounted, so as to pivot, with an axle 56 in an axle holder 531 arranged in the bearing block 53 for this purpose. The clamping piece 55 is also produced from an elastomer material. Two arms 57, 58 that lie opposite one another are formed on the axle 56. In this regard, a first arm 57 is configured radial to the axle 56, and the second arm 58 is configured in arc shape, running toward the first arm, wherein the first arm 57 projects beyond the second arm 58 in terms of its length. The distance between the two arms 57, 58 essentially corresponds to the thickness of the door panel 30, which is configured as a glass pane in the exemplary embodiment.

The clamping piece is configured in such a manner that the door panel 30 lies against the first arm 57 with a side edge in the open state. In this regard, a torsion spring—now shown—is provided, by way of which the first arm 57 is pre-loaded against the door panel 30. If the door panel 30 is pivoted in the opening direction, then it is moved out of the clamping piece 55, as shown in FIG. 18 a). When the door panel 30 is pivoted into the closing position, it slides in between the arms 57, 58 of the clamping piece 55, by means of which it is held in the closed position. The arms 57, 58 of the clamping piece 55 are dimensioned in such a manner that the door panel 30 can move along the displacement distance required for the closing position, within the clamping piece 55, without sliding out of the clamping piece 55. Furthermore, due to the clamping effect of the elastically configured clamping piece 55, an unintended movement of the door panel out of its closing position is prevented. In deviation from FIG. 18, multiple bearing blocks holding a clamping piece can also be arranged in the side profile, and thereby it is possible to achieve an increased stabilization effect.

Of course, the invention is not restricted to the above exemplary embodiments. For example, the engagement point of the drive can lie both on the door panel itself and on parts connected with it, such as, for example, on support parts that are guided in the ceiling rail or the floor rail. Also, the operating part for activating a drive can be arranged at any suitable location, depending on the design of the drive, not only on the door panel but on the side profile or on a ceiling rail or floor rail.

1. A slide-and swing sash system, comprising
at least one rail profile (1, 2),
at least two sashes (3), which are each displaceably mounted in the at least one rail profile (1, 2) by way of two support elements (4), wherein the at least one rail profile (1, 2) has a lateral outlet opening (13) for releasing a support element (4) of a sash (3), and wherein a sash (30) functions as a door sash that can be pivoted into the remaining opening in the latched state of all the other sashes (3),
as well as a closure mechanism (6, 7), by way of which opening of the door sash (3) can be prevented,
wherein the closure mechanism (6, 7) comprises a drive as well as an operating part (61, 72), by way of which the drive can be activated, wherein the door sash (30) can be displaced in the rail profile (1, 2), in the direction of the adjacent sash (3), by way of the drive, to such an extent that no support element (4) of the door sash (30) aligns with the outlet opening (13), and thereby exiting of a support element (4) through the lateral outlet opening (13) is prevented.

2. The slide-and-swing sash system according to claim 1, wherein a ceiling rail profile (1) and a floor rail profile (2) are provided, which each have a lateral outlet opening (13, 21) and in which the at least two sashes (3) are guided.

3. The slide-and-swing sash system according to claim 1, wherein a side profile (5) is arranged orthogonal to the at least one rail profile (1, 2), which side profile forms a counter-bearing for the drive.

4. The slide-and-swing sash system according to claim 1, wherein the operating part is an operating lever (61, 72), and the drive is a mechanical drive that is configured in such a manner that a rotational movement of the operating lever (61, 72) can be converted to a horizontal movement along the rail profile (1, 2) or parallel to it, wherein the operating lever (61, 72) can be fixed in place, in particular locked in place, preferably at least in the closed position.

5. The slide-and-swing sash system according to claim 4, wherein the drive is arranged on the door sash (30) and has a thrust element (73) that is connected with a side profile (5) that is provided, in the pivoted-in position of the door sash (30), and can be moved out against the side profile (5) by means of rotation of the operating lever (72), which profile functions as a counter-bearing, and thereby a thrust force on the door sash (30) is brought about.

6. The slide-and-swing sash system according to claim 5, wherein a holding block (51) is arranged in the side profile (5), which block has a holder (52) for the thrust element (73), into which holder the thrust element (73) engages in the pivoted-in position of the door sash (30).

7. The slide-and-swing sash system according to claim 4, wherein the drive is arranged on the side profile (5) and has a thrust element (93) that is connected with the door sash (30) in the pivoted-in position of the latter, with shape fit, wherein the thrust element (93) can be moved out against the door sash (30) by means of rotation of the operating lever, and thereby a thrust force on the door sash (30) is brought about.

8. The slide-and-swing sash system according to claim 7, wherein a mushroom head (35) is arranged on the door sash (30), which head engages into a T-shaped recess (931) of the thrust element (93) when the door sash (30) is pivoted in.

9. The slide-and-swing sash system according to claim 4, wherein the drive is arranged on a side profile (5) and comprises a thrust rod (62) that can be displaced vertically by means of rotation of the operating lever (61), and is connected with a thrust piece (65) that is connected with the door sash (30), by way of a transformation arrangement, wherein the transformation arrangement is set up for transforming a vertical movement of the thrust rod (62) into a horizontal movement of the thrust piece (65).

10. The slide-and-swing sash system according to claim 9, wherein the transformation arrangement has a cam disk (66), a crank drive or a gearwheel mechanism for redirection of a vertical movement of the thrust rod (62) into a horizontal movement of the thrust piece (65).

11. The slide-and-swing sash system according to claim 9, wherein the transformation arrangement comprises a compulsory guide that is connected with the thrust piece (65) and in which an entrainer part connected with the thrust rod (62) is guided.

12. The slide-and-swing sash system according to claim 11, wherein the entrainer part is formed by a slide pin (63) set against the thrust rod (62) at an angle, which pin is compulsorily guided in the channel (64) of the thrust piece (65).

13. The slide-and-swing sash system according to claim 12, wherein the slide pin (63) is set against the thrust rod (62) at an angle of between 30° and 55°, preferably between 35° and 50°, particularly preferably of 45°.

14. The slide-and-swing sash system according to claim 9, wherein the thrust piece (65) is preferably connected with the support part (4) of the door sash (30) on the ceiling side.

15. The slide-and-swing sash system according to claim 14, wherein the thrust piece (65) projects into the ceiling rail profile (1).

16. The slide-and-swing sash system according to claim 3, wherein a clamping piece (55) is mounted in the side profile (5) so as to pivot, which piece surrounds the door sash (30) in the closed position.

17. The slide-and-swing sash system according to claim 16, wherein the clamping piece (55) has two holding arms (57, 58) arranged opposite one another, between which the door sash (30) slides when it is pivoted into the closed position, and out of which it slides when it is pivoted out of the closed position.

18. The slide-and-swing sash system according to claim 16, wherein a bearing block (53) is introduced into the side profile (5), which block has an axle holder (531) into which an axle (56) of the clamping piece (55) engages, wherein the clamping piece (55) is guided by means of a recess (54) introduced into the side profile (5) for this purpose.

19. The slide-and-swing sash system according to claim 18, wherein a spring element is provided, by way of which the clamping piece is pre-loaded in a pivoting direction.

20. The slide-and-swing sash system according to claim 16, wherein the clamping piece (55) and/or the bearing block is/are produced from plastic, preferably from an elastomer material.
